(19) United States
(12) Patent Application Publication
(10) Pub. No.: US 2003/0063271 A1
(43) Pub. Date: Apr. 3, 2003

(54) Sampling and measurement system with multiple slurry chemical manifold

(76) Inventors: Mary Kristin Nicholes, Eden Prairie, MN (US); Debra M. Carrieri, Burnsville, MN (US); Allen D. James, Chanhassen, MN (US)

Correspondence Address: Ira Lee Zebrak, The BOC Group, Inc., Intellectual Property Dept., 100 Mountain Ave., Murray Hill, NJ, 07974, US

(21) Appl. No.: 10/215,799

(22) Filed: Aug. 9, 2002

Related U.S. Application Data
(60) Provisional application No. 60/313,440, filed on Aug. 17, 2001.

(51) Int. Cl. G01N 1/00

(52) U.S. Cl. 356/36

(57) ABSTRACT

A sampling system for use with an optical particle analyzer is disclosed. The sampling system includes a manifold having multiple ports, with each port receiving a chemical-mechanical polishing slurry. Each of the slurries enter the manifold through a separate slurry line. The optical particle analyzer is in operational association with the manifold in order to selectively measure the slurries after going through the manifold. The system flushes the manifold with a flushing fluid, such as ultra-pure water, to flush the slurry sample out of the manifold, followed by a purging with nitrogen to remove the ultra-pure water from the manifold, overall contributing to optimal slurry measurement. The system permits sampling of multiple slurries with a single particle analyzer.

### CROSS-REFERENCE TO RELATED APPLICATION

This application claims priority of U.S. Provisional Patent Application No. 60/313,440 filed on Aug. 17, 2001.

### BACKGROUND OF THE INVENTION

The present invention relates generally to liquid sampling systems, and more particularly, to a chemical-mechanical polishing slurry sampling system that allows the measurement of multiple slurries at multiple sampling points with a single optical particle analyzer and utilizes a flushing and purging system to optimize the sampling of the slurries.

One of the problems associated with current optical particle analyzers or counters is that they generally are only capable of sampling one slurry in conjunction with a single sampling point. Therefore, in order to analyze more than one slurry, having multiple sampling points, it typically would be necessary to utilize one optical particle analyzer/counter for each sample point. In the integrated circuit manufacturing arena, it is often desired to analyze multiple sets of chemical-mechanical polishing slurries, and therefore a one-to-one ratio of analyzer to slurry to be tested dramatically increases the costs to these manufacturers. Therefore, it would be desirable to have a system that incorporates an optical particle counter/analyzer and that allows the analyzer to sample any of a number of slurries at multiple sampling points.

Additionally, it would be desirable to have a slurry sampling system that minimizes background particle concentration and cross-contamination with respect to the analyzed slurry in a multiple slurry sampling system.

### SUMMARY OF THE INVENTION

The present invention provides a sampling and measurement system that overcomes the aforementioned problems, and allows the measurement of multiple slurries at multiple sampling points with a single optical particle analyzer, and that utilizes a flushing and purging system to optimize the accuracy of sampling of multiple slurries. The invention provides a methodology for flushing, purging, orienting and controlling the system such that the integrity of the analyzed slurry is maintained and such that background particle concentration in the system is minimized.

In accordance with one aspect of the invention, a slurry sampling system for use with a plurality of slurry samples supplied by a plurality of slurry supply lines is disclosed. The slurry sampling system includes an analyzer for optically analyzing particles within the slurry samples. A manifold is in operational association with the analyzer and has a plurality of inlet ports to selectively receive the slurry samples from the slurry supply lines, each inlet port associated with one of the slurry samples, and includes an outlet port capable of allowing each of the slurry samples to exit the manifold and proceed to the analyzer. The manifold and the analyzer operate such that each of the slurry samples may be selectively passed through the manifold and subsequently collected and analyzed by the analyzer without contamination from any other of the slurry samples.

In accordance with another aspect of the invention, a sampling system is disclosed and includes a single optical particle counter for measuring a plurality of chemical-mechanical polishing slurries, and a manifold in operational association with the optical particle counter. The manifold includes a plurality of ports capable of selectively receiving the chemical-mechanical polishing slurries to be analyzed by the optical particle counter.

In accordance with another aspect of the invention, a method of multiple slurry sampling measurement is disclosed. The method includes flushing a manifold with a flushing fluid, flushing an analyzer sample loop with the flushing fluid, and collecting and analyzing the flushing fluid with an analyzer. The method also includes purging the manifold and the analyzer sample loop with a purging gas to remove the flushing fluid, selectively passing a slurry sample through the manifold, sampling the slurry sample with the analyzer, and analyzing the slurry sample.

Various other features, objects and advantages of the present invention will be made apparent from the following detailed description and the drawings.

### BRIEF DESCRIPTION OF THE DRAWINGS

The drawings illustrate a preferred mode presently contemplated for carrying out the invention.

In the drawings:

FIG. 1 is a schematic representation of the intelligent slurry particle equipment (iSPEQ) in accordance with one aspect of the present invention.

FIG. 2 is a flowchart illustrating the start-up process associated with the iSPEQ system of the present invention.

FIG. 3 is a flowchart illustrating an overview of the flushing procedures associated with the iSPEQ system of the present invention.

FIG. 4 is a flowchart illustrating the detail of a manifold flushing procedure associated with the iSPEQ system of the present invention.

FIG. 5 is a flowchart illustrating the detail of a software-initiated flushing procedure associated with the iSPEQ system of the present invention.

FIG. 6 is a flowchart illustrating the detail of a manifold purging procedure associated with the iSPEQ system of the present invention.

FIG. 7 is a flowchart illustrating the iSPEQ system of the process in the automatic mode.

FIG. 8 is a flowchart illustrating the iSPEQ system of the process in the bottle sampling mode.

FIG. 9 is a flowchart illustrating the iSPEQ system of the process in a manual sampling from a supply mode.

FIG. 10 is a flowchart illustrating the iSPEQ system of the process in a manual sampling from a bottle mode.

FIG. 11 is a flowchart illustrating the chemical cleaning process associated with the iSPEQ system of the present invention.

FIG. 12 is a flowchart illustrating the measurement procedures associated with the iSPEQ system of the present invention.

FIG. 13 is a flowchart illustrating the queuing process associated with the iSPEQ system of the present invention.

FIG. 14 is a flowchart illustrating the shutdown mode of the iSPEQ system of the present invention.

### DETAILED DESCRIPTION OF THE PREFERRED EMBODIMENT

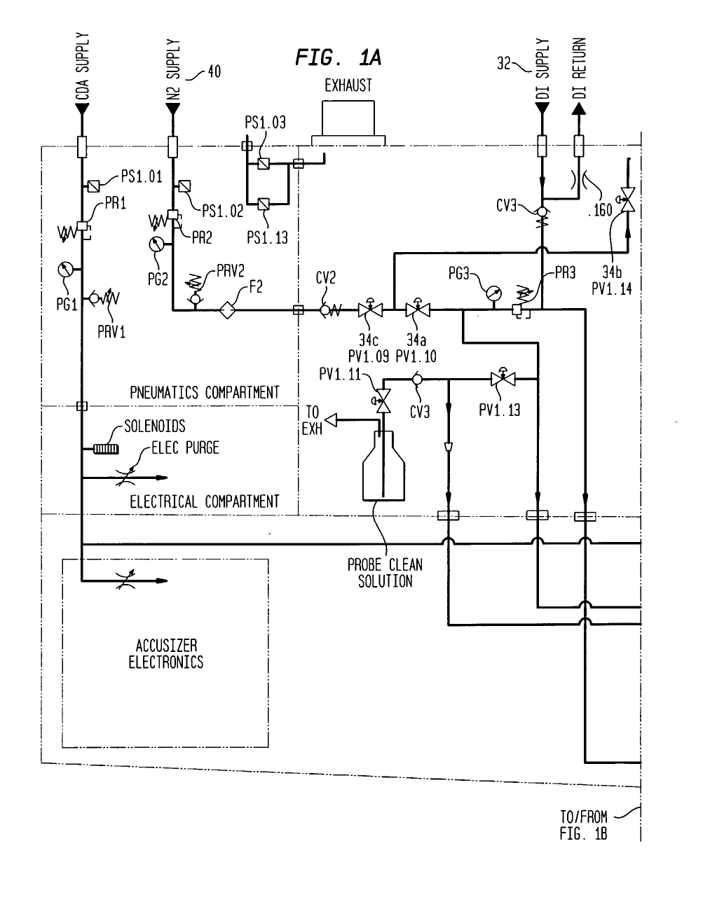

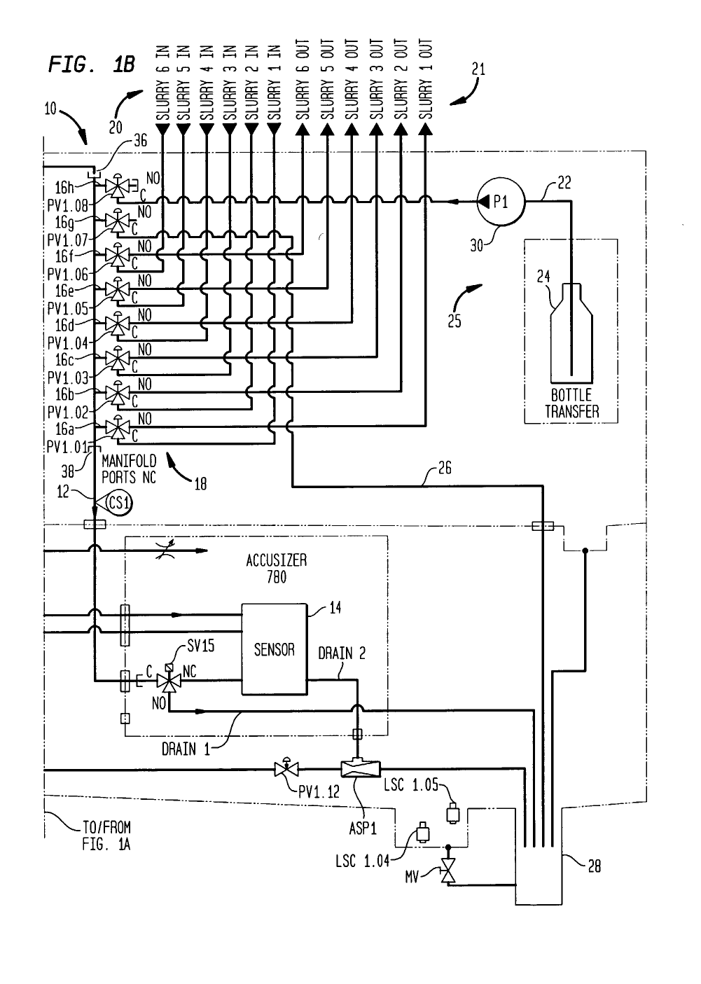

Referring now to FIG. 1, a schematic representation of the system of the present invention is shown generally by the numeral 10. The system 10 is known as the intelligent Slurry Particle Equipment (iSPEQ) system. The purpose of the iSPEQ system 10 is to monitor the health of chemical-mechanical polishing slurries. To accomplish this, the system 10 includes a manifold 12. The manifold 12 is used to selectively deliver a desired slurry to a particle analyzer/sensor 14. A particular sensor 14 may be found by Particle Sizing Systems Inc. of Santa Barbara, Calif., and is described in U.S. Pat. No. 5,835,211. Such single particle optical sensors may be used, although any particle sensor providing the appropriate analysis of the chemical slurries may be suitably employed. The manifold 12 has a plurality of manifold inlet ports 16A-H, each manifold port intake associated with a manifold valve (collectively 18 ). Although eight ports are shown and preferred, it is contemplated that any number of ports desired may be used in the present invention. In the preferred embodiment shown, the eight manifold inlet ports are connected to six slurry input lines 20, a bottle sample line 22, which draws a slurry sample from bottle 24, and a drain line 26 which is connected to the system drain 28. When desired, system 10 may draw from any of the slurry input lines 20 or pump the sample from the bottle 24 with pump 30 to draw the slurry sample through sample line 22 (by way of the valves 16h) into the manifold 12.

In addition to chemical slurries, in operation, manifold 12 also receives other fluids and gases therethrough. For example, during the manifold flushing process, a flushing fluid or liquid (preferably de-ionized water or ultra-pure water) is drawn from DI supply 32 and follows a supply path past pressure valve 34A and 34B and into the manifold intake 36 such that the flushing liquid may pass through the manifold 12 and exit manifold outlet 38.

Moreover, prior to a manifold purge when it is desired to purge the manifold 12 (or as part of a system purge), nitrogen, argon, ultra-pure gas, inert gas or other suitable purge gas is drawn from the nitrogen supply 40 through a nitrogen supply line that passes valve 34C and 34B and again through the manifold intake 36 and into manifold 12, until exiting manifold outlet 38.

Manifold

The iSPEQ system 10 uses a chemical-mechanical polishing manifold 12, more specifically a multi-port valve manifold, as one integral component. The typical multi-port valve manifold is schematically illustrated, as it is found in the iSPEQ system. The manifold is comprised of a top, a bottom, and perimeter walls that are disposed between and extend from the top to the bottom to enclose the manifold and define a manifold interior volume and an interior pressure. This volume of the manifold can take the form of a cylinder, a cube, or otherwise.

The perimeter walls, the top, and the bottom of the manifold all have respective interior and exterior surfaces. An array of apertures extending from the interior surface to the exterior surface of the manifold is longitudinally linearly aligned from proximate the top of the manifold to proximate the bottom of the manifold. These apertures are configured to receive and be associated with a plurality of valves, thus the name multi-port valve manifold. In preferred embodiments, the valves are three-way sampling valves as they are widely referred to and well known in the industry. Each of the valves associated with the manifold has a valve intake, a valve outlet, and a manifold port intake. Each valve intake is configured to receive one of a plurality of slurries from a respective slurry supply line 20. Additionally, each valve outlet may be configured to permit discharge of one of a plurality of slurries into respective slurry outlet lines 21. Finally, each valve is connected to a manifold inlet port. The manifold inlet ports, in combination with the array of linearly aligned valves on the manifold, permit the manifold to be associated with the plurality of valves to receive the respective slurries.

In preferred embodiments, at least one of the plurality of valves associated with the manifold comprises a conduit for accepting fluid, or chemical-mechanical polishing slurry, from a bottle transfer station. The bottle transfer station 25 is associated with one of the plurality of valves and comprises a bottle 24 capable of containing a sample of fluid, or slurry, and a pump for transporting the slurry through the associated line 22.

Also, in preferred embodiments, one of the plurality of valves 16g associated with the manifold comprises a conduit for accessing the system drain. The valve 16g responsible for providing access to the drain is connected to the drain by means of a line 26 that begins at the valve outlet and ends at the system drain 28.

In exemplary embodiments, six valves, in addition to the bottle transfer valve and drain valve, are associated with the multi-port valve manifold. Each of these six valves is associated with a respective slurry line and configured to receive, through one of six connecting individual slurry lines, one of a plurality of different slurries. As slurry is delivered to a selected valve by an individual slurry line, the slurry is received in the respective valve intake. Thus, the manifold is capable of importing at least six different slurries, or any combination thereof, through the six associated valves. Each valve intake may be selectively placed in an open position, to receive a slurry, or a closed position to deny a slurry from entering the manifold. Similarly, each valve outlet may be selectively placed in an open position, to discharge a slurry, or a closed position to deny a slurry from leaving the manifold.

Located proximate the top (in preferred embodiments) of the manifold is a manifold intake 36. The manifold intake is configured to receive a supply of fluid, typically ultra pure water, from a fluid supply line. Fluid flow into the manifold is controlled by a pressure valve located upstream of the manifold intake.

The manifold also comprises a venting port (16g) proximate the top. The venting port has an open position, which allows communication of gas or liquid between the manifold interior and exterior, and a closed position that prohibits such communication. The venting port is incorporated into the manifold top or perimeter wall such that gas pockets containing air, nitrogen, or other gas, may escape from inside the manifold when the vent is in the open position. In preferred embodiments, the vent is located near the top so as to allow trapped gases to more easily escape.

The manifold also comprises an outlet 38 proximate the bottom. This outlet is configured and incorporated in the manifold bottom or perimeter wall such that ultra pure water, or other desired fluid, introduced into the manifold at the manifold intake may be discharged from the manifold. Additionally, the manifold outlet also permits one or more of the plurality of slurries that have been introduced into the manifold to be expelled. Notably, the manifold outlet is also configured to allow any mixture of fluid and chemical found in the manifold to be expelled as well. Importantly, the outlet also permits gas pockets entrained in a fluid within the manifold to be expelled along with a fluid that is being discharged. In preferred embodiments, the outlet is located near the manifold bottom.

As described above, the inventors have found that a pneumatic, eight-port, three-way valve manifold from Saint-Gobain Performance Plastic of Wayne, N.J. (formerly Furon Company) may be suitably employed in the iSPEQ system.

The present invention is used preferably with an analyzer or particle sensor that can operate on line with dilution of particles, measure both large and small particles, and measure PSD and other slurry health parameters accurately, such as the AccuSizer, and the inventors have selected the AccuSizer for use in the preferred iSPEQ system. However, any sensor capable of providing PSD and slurry health feedback can be employed in the system.

Despite the positive and negative attributes of individual sensors, all of the sensors share one common trait. In order for any of the sensors capable of performing in the iSPEQ system 10 to function properly, that sensor must be adequately cleaned and rinsed. If this is not accomplished, the sensor will provide errant data. Likewise, for the iSPEQ system as a whole to function properly, the multi-port valve manifold 12, in association with the sensor 14, must be adequately flushed. Without proper flushing, gas pockets entrained in the slurry undesirably affect sensor data. Thus, it is critical that both the manifold and the entire iSPEQ system be flushed, rinsed, purged and otherwise cleansed to sufficiently eliminate gas pockets and contaminants.

Flushing

The inventors have found that flushing features in current analyzers were deficient. Specifically, the flushing performed by some sensors did not solve the problem of gas pockets within the manifold being released and causing erratic sensor readings. Absent proper flushing, testing revealed that the system did not operate properly and could not provide worthwhile data. When using multiple slurries, this could contaminate data for many slurry samples. At the very least, a system for flushing the manifold in the system sufficiently free of gas pockets and other contaminants was needed. If any gas pockets expelled by the manifold reach the sensor while the system is in use, the accuracy of sensor data will be compromised.

The task of removing gas pockets from the manifold proved to be difficult since gas pockets within the system have a tendency to hide in crevasses or cling to component walls. Also, removal of gas bubbles is especially difficult at relatively low pressures. To solve this problem, the inventors have devised a novel method of rinsing the valve manifold. Testing revealed that if the valve manifold were not properly flushed, by a specific method using an ultra pure water, then gas pockets, and even some unwanted particles, remained in the iSPEQ system. While the rinsing method is described for a valve chemical-mechanical polishing manifold, and more specifically a multi-port valve manifold, the inventors contemplate that the method is equally applicable to other system components and may have other practical applications. However, when using multiple slurries in the same manifold, proper rinsing is critical to avoid cross-contamination.

The sensor valve comprises a sensor valve intake, a sensor valve outlet, and a sensor port intake. The sensor valve connected to the manifold drain line receives fluid from the manifold at the sensor valve intake. The sensor valve may be selectively placed in an open position or a closed position to route fluid as desired. In the open position, the sensor valve routes fluid to the sensor port intake. The sensor port intake is associated with the sensor by a spur of the manifold drain line. In the closed position, the sensor valve routes fluid through the sensor valve outlet whereby the fluid passes around the sensor. Any fluid that is routed past the sensor through the sensor valve outlet is emptied into the system drain that is associated, by a different spur of the manifold drain line, with the system drain. Normally, the sensor valve is found in the closed position to protect the sensor from damage. Only in specific instances will the sensor valve permit fluid into the sensor.

By providing an open manifold outlet at the outset of the flushing process, in addition to allowing any remaining fluid within the manifold to drain, a path for expelling fluid from the iSPEQ system is established. By creating this path, a flow of fluid that will be established later in the flushing procedure, is permitted through the manifold as the fluid is continually introduced. In preferred embodiments, this fluid is ultra pure water. This flow of ultra pure water allows at least some portion of the entrained pockets of gas and contaminants located within the manifold to be discharged at the manifold outlet. Unfortunately, just providing a flow of ultra pure water through the manifold has not been found to remove a sufficient amount of gas pockets from the manifold.

After the flow of ultra pure water is established, the vent located proximate the top of the manifold is opened. When the vent is opened, gases within the manifold are permitted to escape. This is especially true when a fluid is introduced into the manifold. As the level or depth of fluid within the manifold rises, the gases also rise and are expelled from the manifold by the open vent located proximate the top of the manifold.

Also, expulsion of gas pockets is encouraged at the manifold outlet when the vent is opened. The flow of fluid urges entrained gases to vacate the manifold interior. By opening the vent, the pressure inside the manifold does not significantly drop when a fluid is expelled from the manifold outlet at the bottom of the manifold. If manifold remains air tight as fluid exits at the manifold outlet, a vacuum is produced within the manifold. As this happens, outside air might be persuaded to enter the manifold at the outlet. Thus, air would undesirably be introduced into the manifold. However, with the vent opened, the manifold interior pressure can equalize with the pressure outside the manifold and the flow of fluid out of the manifold does not act to inhale air through the outlet.

Finally, when the vent is opened, flow through the manifold is encouraged. Any fluid that may be introduced into the manifold, while the vent is open, is able to flow without significant impediment. As such, the drag created on the flowing fluid is minimal and a predominantly laminar flow through the manifold can be achieved. Normally, fluids flowing with less turbulence have fewer gas pockets entrained therein. Thus, the fluid flowing though the manifold while the vent is opened encourages any pockets of gas to follow the fluid through the manifold outlet and discourages any pockets of gas from being formed.

After the vent and manifold outlet are opened, a fluid is introduced into the manifold through the manifold intake. The fluid being introduced is intended to provide all of the benefits that a flowing fluid, as described above, can provide. In preferred embodiments, the fluid introduced into the manifold through the intake is ultra pure water. Ultra pure water, or UPW, is water that is substantially free of impurities. Because ultra pure water is de-ionized, it is also often referred to as DI water. Several grades of ultra pure water are well known and commercially available. In preferred embodiments, the inventors contemplate the use of a semiconductor grade of ultra pure water, although other grades may be used.

Ultra pure water is introduced into the manifold until the manifold is substantially filled. Despite the outlet at the bottom of the manifold being open, the flow of ultra pure water in through the manifold intake is sufficiently greater than the flow of ultra pure water out of the manifold through the manifold outlet. In order to achieve this result, the rate of flow of ultra pure water into the manifold must be greater than the rate of flow of ultra pure water exiting the manifold. Alternatively, the volume of water received by the manifold intake must be substantially greater than the volume of water exiting the manifold. Either way, the manifold should be substantially filled with ultra pure water. In order to make the determination regarding whether the manifold has been substantially filled with ultra pure water, the vent proximate the top of the manifold may be monitored for a discharge of water. If water is leaving through the vent, the manifold is substantially filled.

In operation, for example to measure slurry 1 (in auto mode, the de-ionized water will flow from the DI supply through PV1.10 and PV1.14 and into the manifold through the manifold intake in order to flush ultra-pure water through the manifold. The water exits the manifold outlet and through the common to normally open portions of SV15 to drain 1. This is done in order to clear the manifold of any previous material. A signal is then sent to the AccuSizer from the electrical compartment of the iSPEQ to activate SV15 such that the water is then directed into the AccuSizer sensor in order to get a background count of the water. This is best accomplished by measuring the water after having flowed through the manifold. Upon completion, the AccuSizer will send an idle signal after which the water is purged. The purging process occurs by directing the nitrogen from the N2 supply through valves PV1.09 and PV1.14 into the manifold for a manifold purge time. Upon exiting the manifold, the nitrogen flows from the common to normally open valve portions of SV15 and ultimately to drain 1. Following the nitrogen purge, slurry is drawn through the supply 1 valve PV1.01 into the manifold, exiting through the manifold outlet and to initially through SV15 from the common to the normally open valve to the system drain. This is to ensure that a first portion of the slurry is not used in the sensor. This slurry is drawn to the system drain for a manifold fill time, after which a software signal is sent to the AccuSizer electronics at which point the AccuSizer activates SV15 and slurry flows through the common to normally closed portions of SV15 directly into the sensor for analysis. After a time of the measuring of the slurry, the flushing of the slurry begins, so there is some overlap between the flushing and the AccuSizer slurry measuring. Because the slurry settles quickly, it is desirable that the slurry not be present in the manifold for a relatively long period of time. Therefore, at the earliest opportunity the slurry is flushed from the manifold again by activating PV1.10 and PV1.14 and allowing de-ionized water to flow into the manifold, thereby flushing the manifold through the common to normally open portions of SV15 to the system drain.

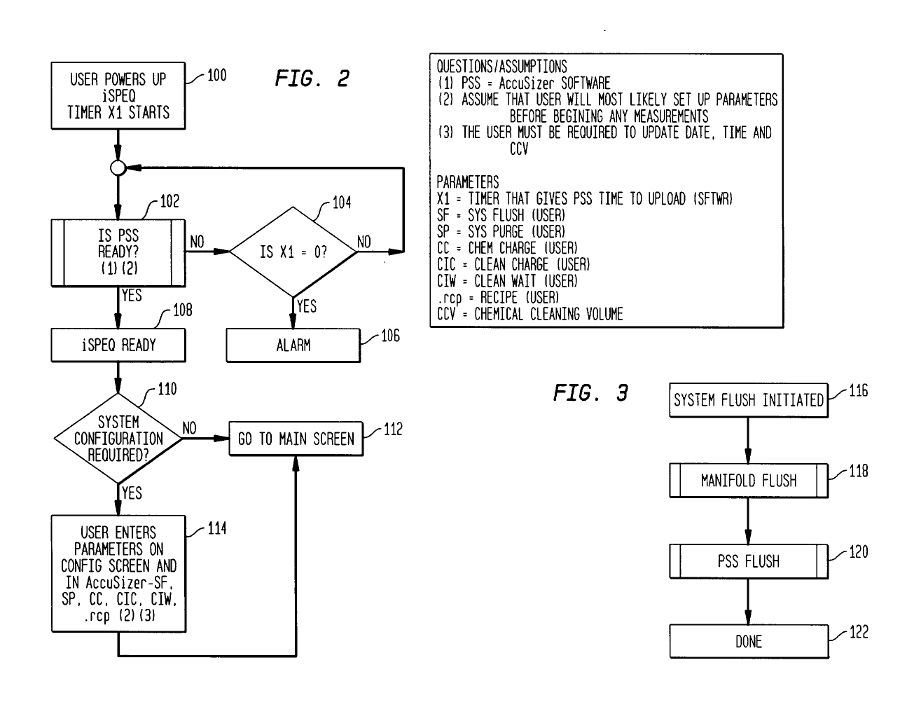

Referring now to FIG. 2, a flow chart is shown to illustrate the start-up procedures associated with the system of the present invention. For this Figure, the parameters are as follows:

| | |
|---|---|
| X1 = | Timer that gives PSS time to upload |
| SF = | Sys Flush |
| SP = | Sys Purge |
| CC = | Chem Charge |
| CIC = | Clean Charge |
| CIW = | Clean Wait |
| .rcp = | Recipe |
| CCV = | Chemical Cleaning Volume |

The user initially powers up the system 100 and the timer that allows the software time to upload starts. It is then determined 102 whether the software is ready. If not, a check is made 104 to determine whether the timer has run to zero 104. If yes, an alarm 106 is initiated. If not, another check 102 is made. If it is determined that the software is ready, the system is determined to be ready 108 and a determination is made whether the system configuration is required 110. If not, the start-up procedure goes directly to a main screen 112 associated with the start-up procedure. If system configuration is required 114, the user enters parameters on a configuration screen and within the particle sensor itself. Such parameters may include a system flush timer, a system purge timer, a chemical charge timer, a clean charge timer, a clean wait timer, a recipe, where the user is required to update the date, time and chemical cleaning volume.

Referring now to FIG. 3, a flowchart is shown to illustrate an overview of the system process flow. At the beginning, a system flush is initiated 116, and thereafter a manifold flush 118 is instituted for flushing out the manifold with a liquid, preferably ultra-pure water. The particle analyzer is also flushed 120 with the liquid or ultra-pure water. When both the manifold flush 118 and the particle sensor flush 120 are completed, the system flush is then done 122. The iSPEQ system is then measured to determine the background particle counts within the iSPEQ system. This ensures that particle build-up is avoided and enables the user to track the background particle concentrations over time.

Reference is made to safety valves, pressure valves and other check valves, and such valves are in reference to the valves as indicated in FIG. 1.

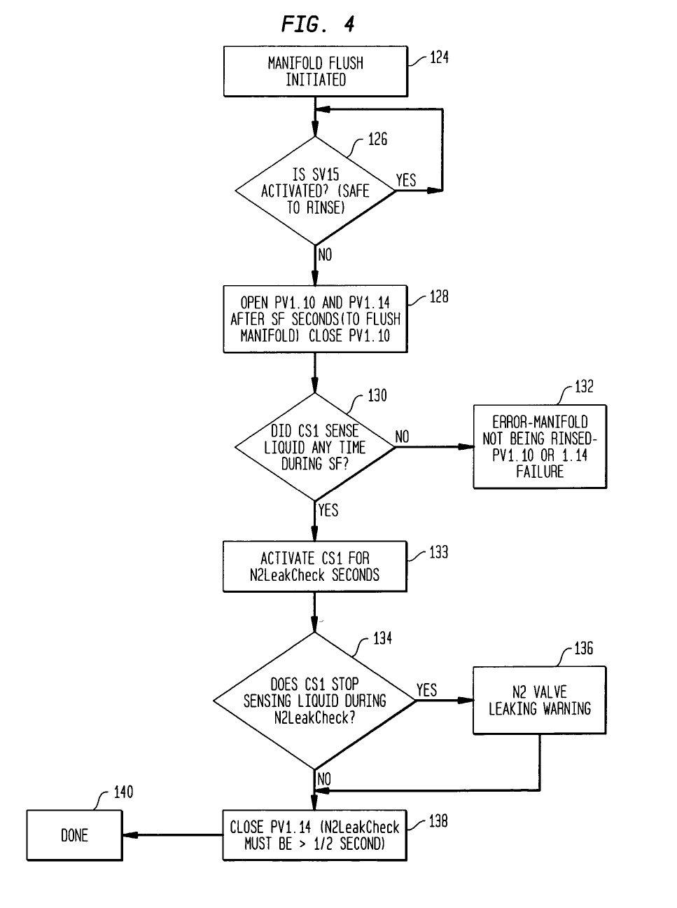

Referring now to FIG. 4, a more detailed flowchart illustrating the manifold flush procedure is illustrated. After the manifold flush is initiated 124, a determination 126 is made whether SV15, which is located near the sensor, is activated so as to determine whether it is safe to continue. If yes, the inquiry continues until it is determined that SV15 is not activated, in which case 128 PV1.10. and PV1.14 are opened. After a given period SF, in order to flush the manifold, PV1.10 is closed. Following this, a determination is made 130 whether a control sensor, or CS1, sensed any liquid at any time during the flushing period. If not 132 an error message is instituted indicating that the manifold is not being rinsed or that there is a failure in one of the valves, in this case PV1.10 or PV1.14. If the control sensor did sense liquid during the flushing of the manifold 133, control sensor CS1 is activated for a predetermined amount of time, indicated by the parameter N2LeakCheck seconds. A check is made 134 to determine whether the control sensor CS1 stopped sensing liquid during the period N2LeakCheck. If so, a warning is issued regarding valve leakage, particularly of valve associated with the nitrogen supply N2. If the sensor does not stop sensing liquid 136, PV1.14 is closed under the assumption that the check of 134, in a preferred embodiment, is greater than ½ a second. Following the closing of the valve 138, the procedure for the manifold to flush is completed 140.

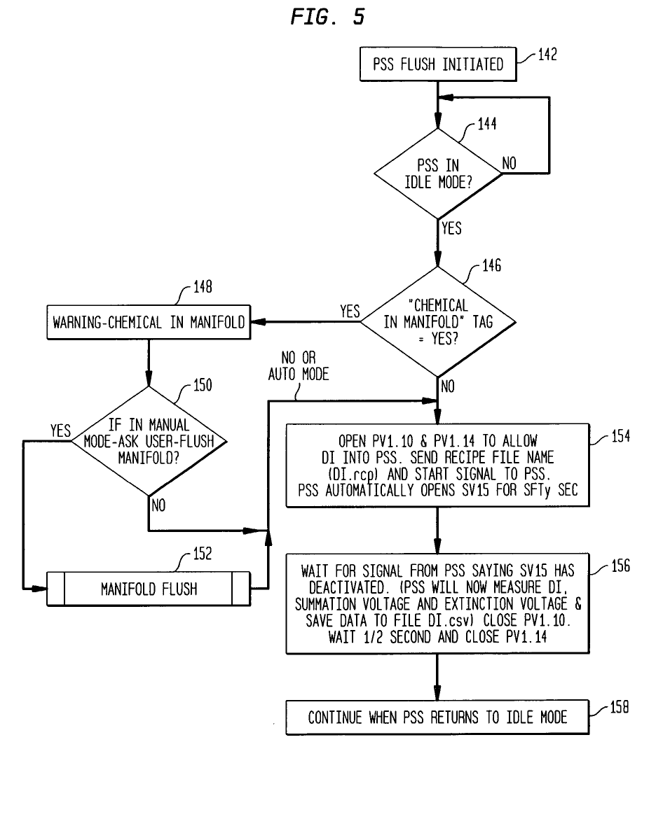

Referring now to FIG. 5, a more detailed flowchart of the particle sensor flushing procedure is shown. After the procedure has been initiated 142, a determination is made 144 as to whether the analyzer is in idle mode. If not, the check 144 continues to be made. If so 146 a determination is made as to whether the tag “Chemical in manifold” is yes. If it is 148 a warning is issued that there is chemical in the manifold. Following this warning 148 a question is asked of the user, if the system is in manual mode, whether the user desires to flush the manifold 150. If yes, the manifold is flushed 152. If the user selects no or the system is in automatic mode, step 154 is initiated to open PV1.10 and PV1.14 in order to allow the liquid, preferably de-ionized or ultra-pure water into the analyzer (or PSS). Particular files and signals are sent to the analyzer. The analyzer also automatically opens the valve SV15 for a predetermined period, as indicated by the parameter SFTy seconds. Following this step, step 156 is initiated in which the system waits for a signal from the analyzer indicating that the valve SV15 has been deactivated. The analyzer then measures the liquid, and other factors such as summation voltage and extinction voltage as well as saving particular data. Valve PV1.10 is also closed. After waiting a particular period, preferably ½ second, PV1.14 is also closed. Finally, after the flush is complete 158 and the analyzer returns to idle mode, the flushing of the analyzer is complete and the system continues operation.

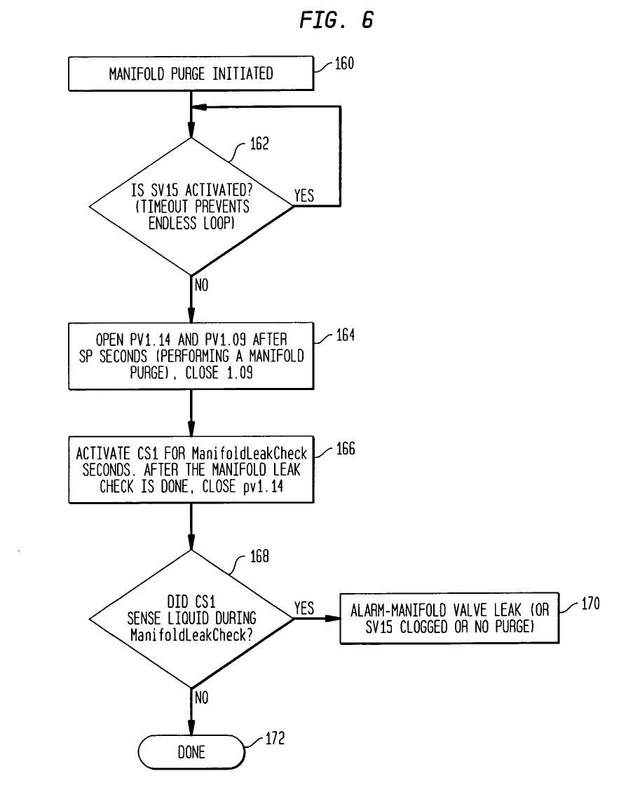

Referring now to FIG. 6, the iSPEQ system of the present invention includes a manifold purge feature, which is illustrated in a detailed flowchart. After a measurement of the remaining liquid (ultra-pure water or other liquid) is complete, the iSPEQ system will automatically purge the valve manifold, preferably with nitrogen or other suitable gas. If the manifold is not purged, then the liquid or ultra-pure water from the system flush will remain in the manifold. After the manifold purge is initiated 160, a check is made 162 to determine whether a valve such as SV15 is activated. While it is activated it will continue to check. A timeout feature prevents an endless loop. When the valve SV15 is no longer activated 164, valves PV1.14 and PV1.09 are opened. This allows the purging material, in this case nitrogen, to flow from the nitrogen supply into the manifold. After a given period, specified by SP seconds, valve PV1.09 is closed. This is followed 166 by the activation of sensor CS1 for a given time, in this case manifold LeakCheck seconds. After the manifold LeakCheck is complete, valve PV1.14 is closed. This prevents any further supply from entering the manifold. Following this a check is made 168 to determine whether the sensor sensed any liquid during the manifold LeakCheck. If so 170 an alarm indicates a manifold valve leak or that the valve SV15 is clogged or that there was no purge during the process. If this sensor CS1 does sense liquid during the duration, in this case manifold LeakCheck 172 the process is complete, and the manifold has been purged of any remaining liquid.

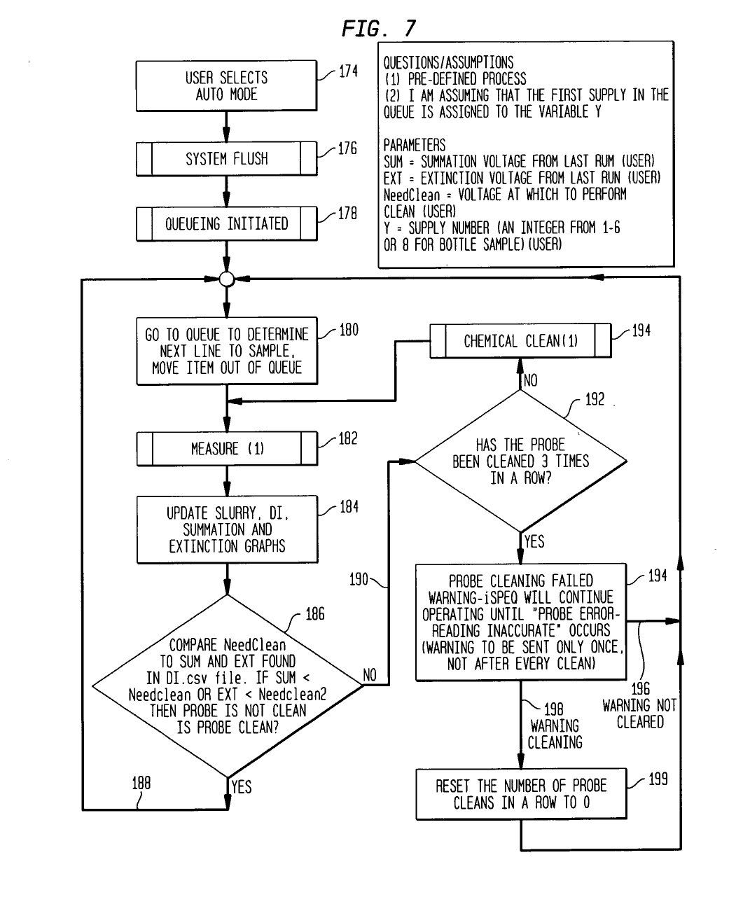

Referring now to FIGS. 7-10, in general, in the preferred embodiment the iSPEQ system is configured to have three modes of operation: auto, manual and bottle sample.

Referring now to FIG. 7, a detailed flowchart of the auto mode is shown. For this Figure, the parameters are as follows:

| | |
|---|---|
| SUM = | Summation voltage from last rum |
| EXT = | Extinction voltage from last run |
| NeedClean = | Voltage at which to perform clean |
| y = | Supply number (an integer from 1-6 or 8 for bottle |
| | sample) |

When the user selects auto mode 174, the iSPEQ initiates a system flush 176. As described before, this function automatically flushes liquid, preferably ultra-pure water, through the valve manifold and then through the analyzer's sample loop. After system flush 176, queueing 178 is initiated, in order to measure the next sample, as in this case a slurry. At 180, in auto mode the system goes to the queue to determine the next slurry line to sample, and to move that item out of the queue. Next, at 182 the sample is measured, and then at 184 particular graphs are updated including slurry de-ionized water levels summation and extinction graphs. Following this, a comparison is made at 186 of a voltage at which to perform the cleaning (need clean voltage) to the summation voltage from the last run as well as the extinction voltage from the last run. If the summation voltage is less than the need clean voltage or the extinction voltage is less than the need clean 2 voltage then the probe is not clean. The determination is then made based on these parameters whether the probe is clean. If yes 188 the queue is initiated to move to the next sample as in step 180. If not 190 it is determined whether the probe has been cleaned a desired number of times in a row, preferably three, in step 192. If not, a chemical clean 194 is performed after which the sample is again measured 182. If the probe has been cleaned three times in a row 194, a probe cleaning failed warning is issued indicating that the iSPEQ will continue operating until probe error reading inaccurate occurs. This warning can be cleared or not cleared. If the warning is not cleared 196 the system goes to the next sample in the queue 180. If the warning is cleared 198, then in 199 the number representative of the number of probe cleanings in a row is reset to zero, after which the system goes to the queue to determine the next sample 180.

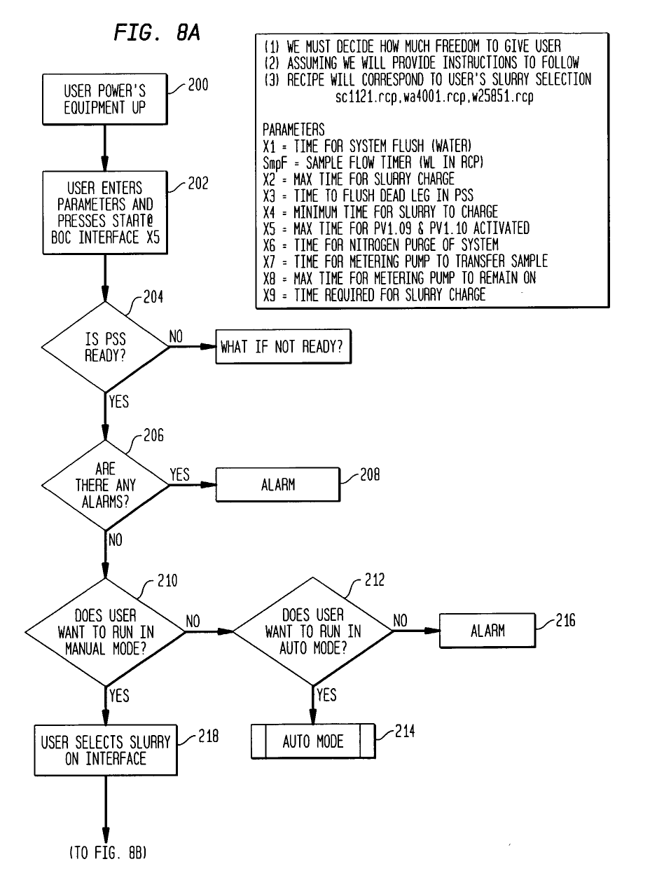

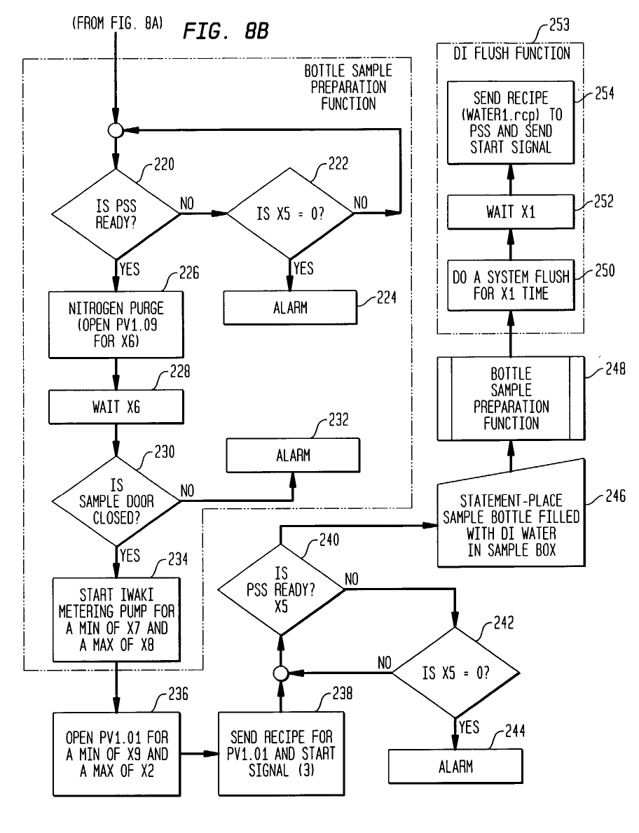

Referring now to FIG. 8, a flowchart of the bottle sample mode of operation of the iSPEQ system is illustrated. For this Figure, the parameters are as follows:

| | |
|---|---|
| X1 = | Time for system flush (water) |
| SmpF = | Sample flow timer (w/in rcp) |
| X2 = | Max time for slurry charge |
| X3 = | Time to flush dead leg in PSS |
| X4 = | Minimum time for slurry to charge |
| X5 = | Max Time for PV1.09 and PV1.10 activated |
| X6 = | Time for Nitrogen purge of system |
| X7 = | Time for metering pump to transfer sample |
| X8 = | Max Time for metering pump to remain on |
| X9 = | Time required for slurry charge |

In this mode, upon 200 powering up the equipment by the user, the user enters 202 parameters and presses start at the system interface. It is then determined whether the analyzer is ready at 204. If not, the system waits until it is ready. If the system is ready, there is a check 206 to determine whether there are any alarms. If so, the alarm is indicated 208. If not, it is determined 210 whether the user wants to run in manual mode. If not, it is determined whether the user wants to run in auto mode 212. If so, the system is run in auto mode 214. If not, an alarm goes off 216. Assuming the user wants to run the system in manual mode, user at 218 selects a slurry on the system interface. Again, it is determined at 220 whether the analyzer is ready. If not, it is determined whether the maximum time for particular valves associated with the nitrogen supply (in this case PV1.09 and PV1.10 ) at step 222 is equal to zero. If yes, an alarm 224 is sounded. If not, the readiness of the sensor is checked at 220. When the analyzer is ready, at step 226 the nitrogen (or other purging gas) purge occurs. This may occur, for example, by opening the valve associated with the nitrogen PV1.09 for a duration associated with the time for nitrogen purge of the system after waiting for that duration 228 it is determined whether the sample doors close 230. If not, an alarm is sounded 232. If so, at 234 a metering pump is started for a desired time. Following this metering pump activation at 236 the valve associated with the bottle sample supply is opened for a desired time. Following this a recipe, or the user's slurry selection, at 238 is sent to the slurry valve (in this case PV1.01 ) and the start signal is also sent. Again, at 240 it is determined whether the analyzer is ready. If not, it is determined whether the maximum time to activate PV1.09 and PV1.10 is equal to zero. If so, an alarm at 244 will sound. When the analyzer is ready at 240, a statement is displayed to place the sample bottle filled with de-ionized water in the sample box at 246. Then the system performs the bottle sample preparation function 248. The user is also asked to place fresh water in the bottle port. That water is then measured. Following this at 250 a system flush is conducted for the system flush duration. After waiting this duration 252, the particular recipe at 254 is sent to the analyzer as well as the signal to start the analysis. Between this the de-ionized water will be flushed through the manifold at 253.

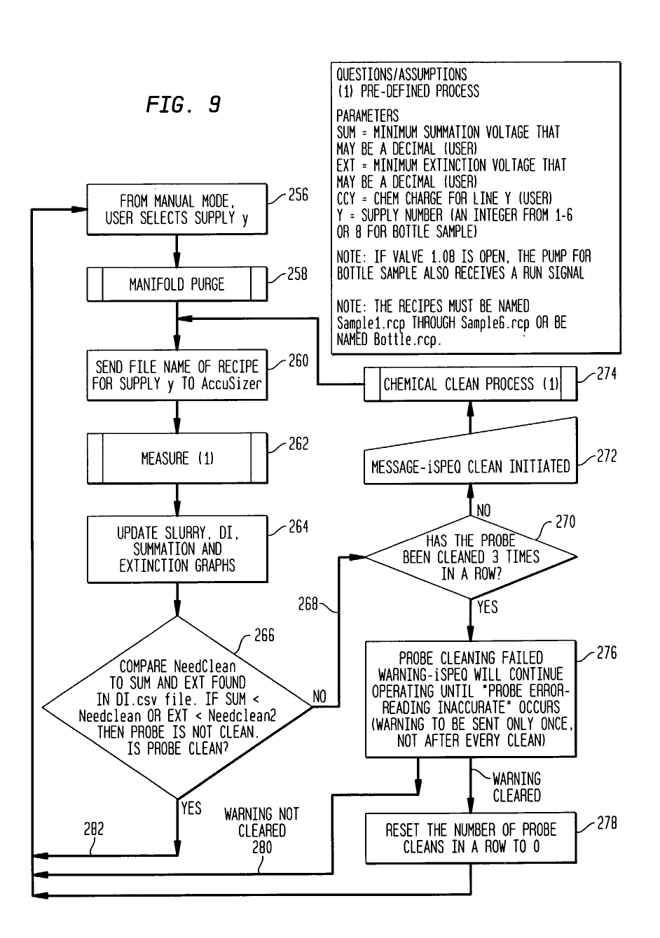

Referring now to FIG. 9, a flowchart illustrating the process for the iSPEQ manual sampling of a supply slurry is shown. For this Figure, the parameters are as follows:

| | |
|---|---|
| SUM = | Minimum summation voltage that may be a decimal |
| EXT = | Minimum extinction voltage that may be a decimal |
| CCy = | Chem Charge for line y |
| y = | Supply number (an integer from 1-6 or 8 for bottle sample) |

This process is used in order to manually sample a particular slurry supply line in a preferred embodiment. Initially, at 256 from the manual mode a user selects which of the slurry lines is desired. Integer y is used to indicate a particular supply line after which at 258 the manifold is purged prior to sampling. After the purging, a file name representative of the recipe for a particular supply slurry 260 is sent to the particle sensor, and thereafter the particular supply is measured 262 followed by updating 264 of slurry de-ionized water summation and extinction graphs. Even determined at 266, by comparing particularized voltages to determine whether the probe is clean. If the probe is not clean 268 it is then inquired whether 270 the probe has been cleaned three times in a row. If not 272 the message is given that the iSPEQ clean is initiated and at 274 the chemical cleaning process begins. After this chemical cleaning process, again the particularized supply slurry recipe is sent to the particle sensor/analyzer. If the probe has been cleaned three times in a row, at 276 a message is issued that the probe cleaning has failed, and that the iSPEQ system will continue to operate until the Probe Error-Reading Inaccurate occurs. If the warning is cleared, at 278 the number of probe cleans is reset to zero and the user is again allowed to select a supply slurry at 256. If the warning is not cleared 280 the user again must select another supply. If the probe is cleaned initially 282 the process may be repeated for another supply slurry at 256.

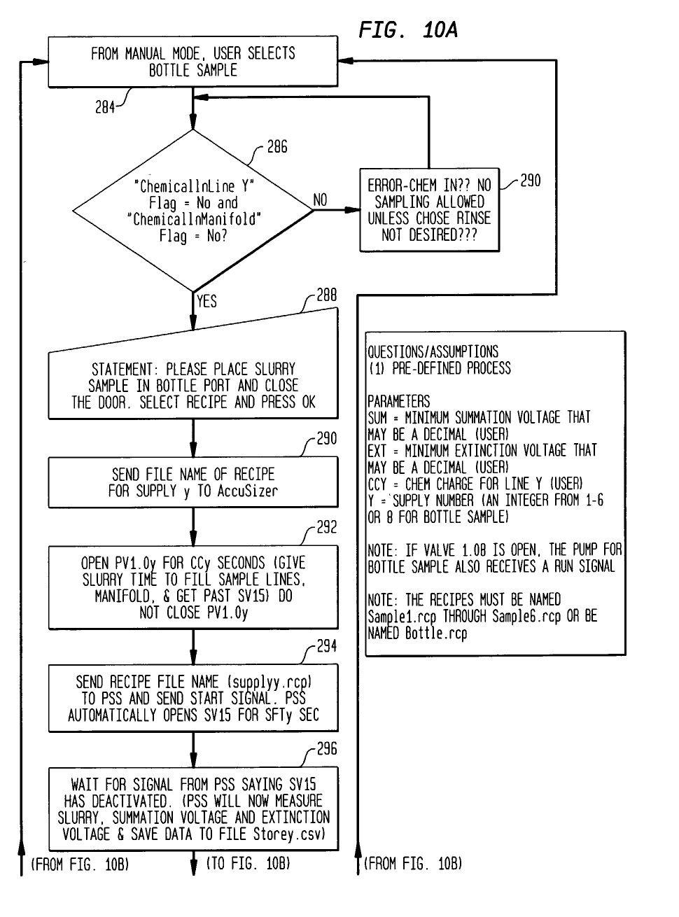

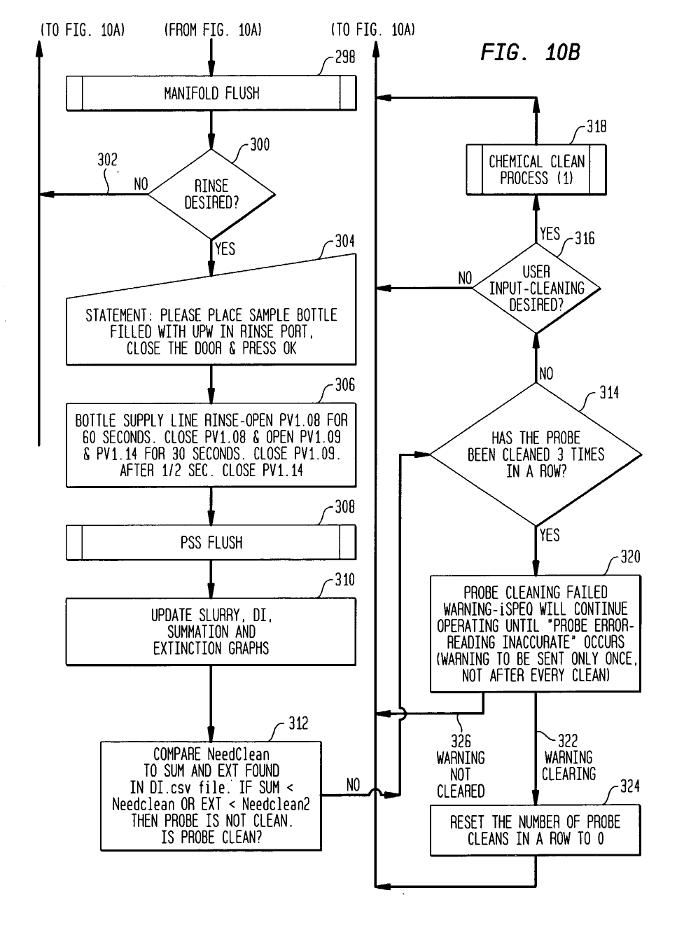

Referring now to FIG. 10, a process for the manual sampling mode for the iSPEQ process is illustrated. For this Figure, the parameters are as follows:

| | |
|---|---|
| SUM = | Minimum summation voltage that may be a decimal |
| EXT = | Minimum extinction voltage that may be a decimal |
| CCy = | Chem Charge for line y |
| y = | Supply number (an integer from 1-6 or 8 for bottle sample) |

In this case, the manual is sampled from a bottle supply of chemical slurry. Again to initiate the process 284 from the manual mode the user selects bottle sample. Several flags are checked to determine whether there is chemical in the slurry line (in this case the bottle sample line) and in the manifold. After this determination 286, if either of the flags are not raised then at 288 the user is asked to place the slurry sample in the bottle port and close the door, select a particular slurry recipe and press OK. If one of the flags is raised, then an error message 290 in which the user is told that no sampling is allowed unless it is desired not to rinse the system. After the user presses OK in 288, in 290 the file name for the particular recipe for the supply slurry is sent to the particle sensor/analyzer. In order to give the slurry time to fill the sample lines, at 292 particular valves are opened for a set parameter. The particular valve that is open corresponds to the valve associated with the particular slurry line desired. It is important that the necessary valves are open such that the slurry can proceed past the sensor inlet valve for analysis. The particular file name for the slurry supply recipe 294 is sent to the particle analyzer along with a start signal, which automatically opens the analyzer valve for a specified time. When the particle sensor sends a signal indicating that the sensor valve has been deactivated 296, the particle sensor will then measure the particular slurry, summation voltage as well as extinction voltage (or any other desired parameters) and save the data to a particular file. Following this measurement, at 298 the manifold is flushed, after which it is inquired 300 whether it is desired to rinse. If not 302 the process is ready for another manual mode selection 284. If rinsing is desired, a message 302 instructs the user to place the sample bottle filled with the rinsing agent (in this case ultra-pure water or UPW) in the rinse port, to close the door and press OK. Once the user complies 306 the bottle supply line rinse occurs by opening the valve inlet connecting the bottle supply line to the manifold for desired periods, in a preferred embodiment for 60 seconds. After closing this valve, the valves connecting the nitrogen supply to the manifold are open for a desired period, in a preferred embodiment 30 seconds after which the valve closest to the nitrogen supply is closed and after a short period (preferably half a second) closing the valve closer to the manifold. Following this procedure, at 308 the flushing of the particle sensor occurs, and updates of the summation voltages and extinction voltages occur 310. Again, the probe cleaning comparisons occur to determine whether the probe is cleaned 312 and 314 whether the probe has been cleaned three times in a row. If it has not the user is asked to indicate whether cleaning is desired 316 and if so, at 318 the chemical cleaning process initiates. If the user does not desire cleaning, the process returns to its starting position 284. If the probe has been cleaned three times in a row, the Probe Cleaning Failed Warning occurs 320 and if the warning is cleared 322 the number of probe cleans is reset to zero 324. If the warning is not cleared 326 the process returns to the initial step 284 to await the user selected mode.

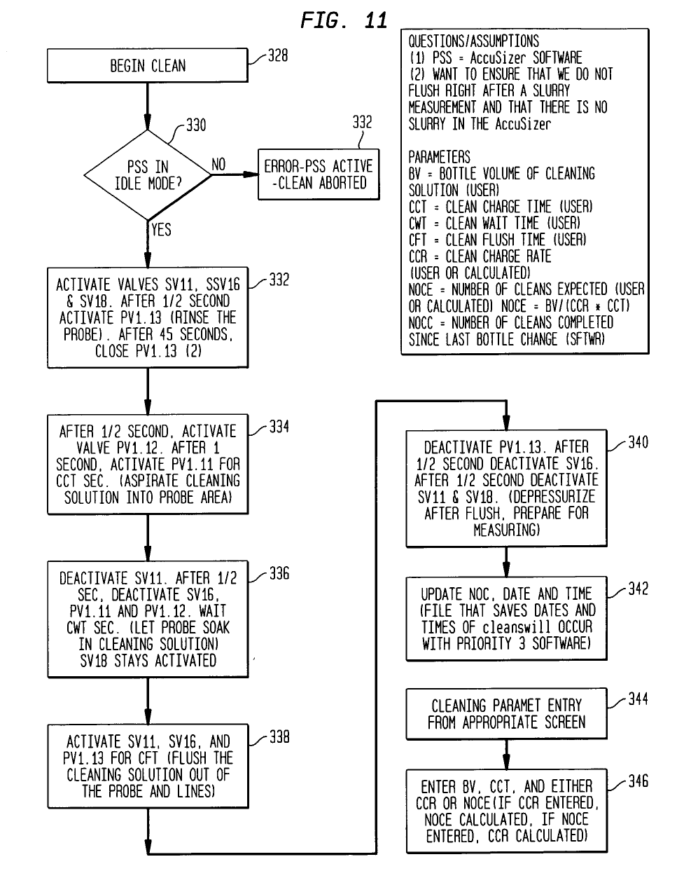

Referring now to FIG. 11, a particular chemical cleaning procedure is illustrated. For this Figure, the parameters are as follows:

| | |
|---|---|
| BV = | Bottle Volume of cleaning solution |
| CCT = | Clean Charge Time |
| CWT = | Clean Wait Time |
| CFT = | Clean Flush Time |
| CCR = | Clean Charge rate |
| NOCE = | Number of Cleans Expected (NOCE = BV/(CCR*CCT) |
| NOCC = | Number of cleans completed since last bottle change |

The process begins 328. It is determined 330 whether the particle sensor is in idle mode and if not an error 332 occurs since the particle sensor is active and the cleaning is aborted. If the particle sensor is in idle mode 332, particular internal particle sensor valves are opened after which a valve connecting the probe cleaning solution to the particle sensor is activated. After a desired time period, preferably 45 seconds in a preferred embodiment, this valve is closed. After the closing of the valve, at 334 after a short time period (preferably half a second) the valve connecting the probe cleaning solution to the aspirator (as well as another valve near the probe cleaning solution is opened) to aspirate the cleaning solution into the probe area. The valves are both left open for a clean charge time, after which 336 the safety valves and pressure valves are deactivated. After a clean wait time to allow the probe to soak in a cleaning solution, at 338 the valves are again activated to flush the cleaning solution out of the probe of the particle analyzer and the lines. After closing the line from the probe cleaning solution to the particle analyzer at 340, the system is depressurized and preparations for measuring occurs. Finally at 342 particular data is updated including the number of cleans, the date and time, into a file that saves the dates and times of the cleanings in a preferred embodiment. In addition, appropriate information must be entered 344 from the appropriate screen including in 346, bottle volume of cleaning solution, clean charge time, clean charge rate, and number of cleans expected.

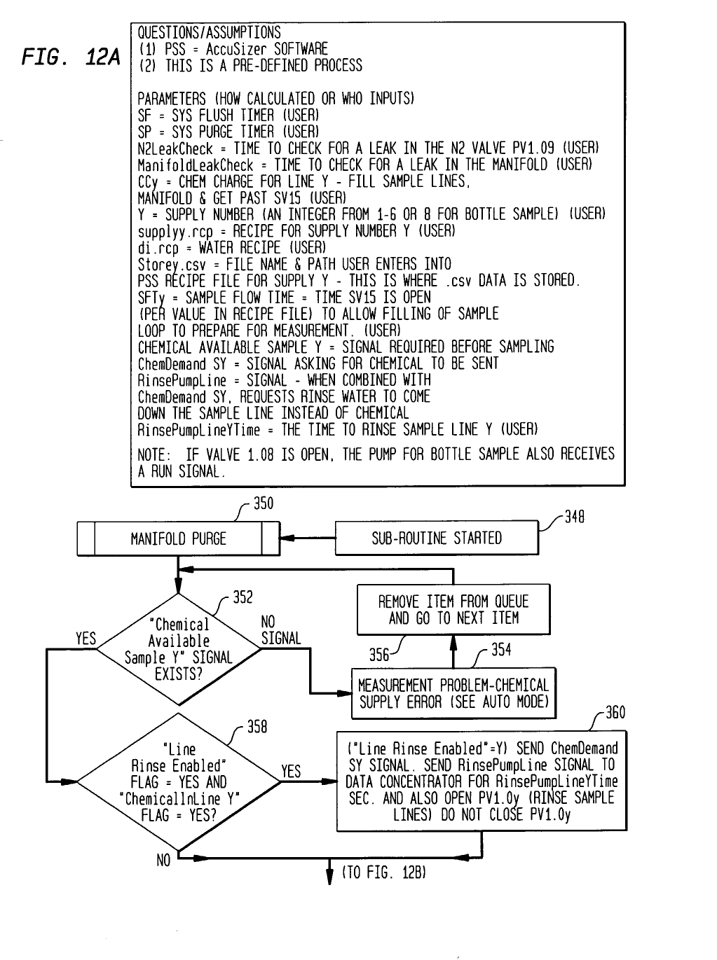

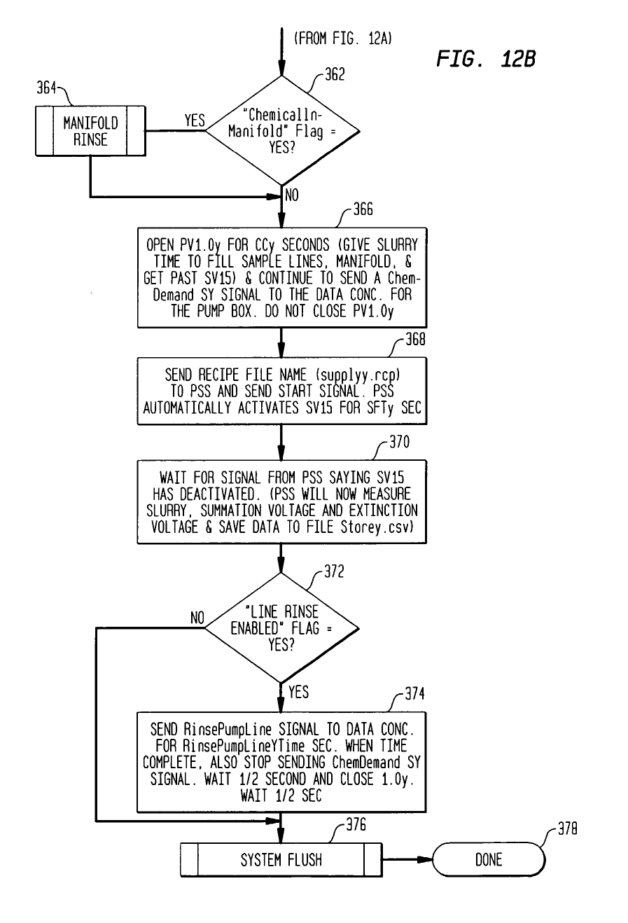

Referring now to FIG. 12, the iSPEQ process flow measurement procedure is illustrated. For this Figure, the parameters are as follows:

| | | |
|---|---|---|
| SF | = | Sys Flush timer |
| SP | = | Sys Purge timer |
| N2LeakCheck | = | Time to check for a leak in the N2 |
| | | valve PV1.09 |
| ManifoldLeakCheck | = | Time to check for a leak in the |
| | | manifold |
| CCy | = | Chem Charge for line y—fill sample |
| | | lines, manifold and get past SV15 |
| y | = | Supply number (an integer from 1-6 |
| | | or 8 for bottle sample) |
| supplyy.rcp | = | Recipe for supply number y |
| di.rcp | = | Water recipe |
| Storey.csv | = | File name and path user enters into |
| PSS recipe file for supply y | | This is where .csv data is stored. |
| SFTy | = | Sample Flow Time = Time SV15 is |
| | | open (per value in recipe file) to |
| | | allow filling of sample loop to |
| | | prepare for measurement |
| Chemical Available Sample Y | = | Signal required before sampling |
| ChemDemand SY | = | Signal asking for chemical to be sent |
| RinsePumpLine | = | Signal—when combined with |
| | | ChemDemand SY, requests rinse |
| | | water to come down the sample line |
| | | instead of chemical |
| RinsePumpLineYTime | = | The time to rinse sample line Y |

Upon beginning 348 the measurement procedure, the manifold is purged 350 to ensure that any of the measurement lines do not contain any previously analyzed slurry or ultra-pure water or other liquid used for flushing. Preferably the manifold purge is completed with nitrogen or other appropriate gas. Following the manifold purge 350, it is queried whether the chemical is available for sample Y, where Y is the supply number of the slurry of interest 352. If the signal indicating available sample is not present, there is an error message 354 that there is a measurement problem or chemical supply error. The item is then 356 removed from the queue and proceeds to the next item. If the signal for the desired slurry sample exists, it is then determined 358 whether the Line Rinse Enabled flag and the chemical in the desired slurry line flag are raised. If so, in 360 the signal that asks for the chemical to be sent. Additionally, the rinse pump line, or the signal that requests rinse water to come down the sample line instead of chemical is sent to the data concentrator for a desired period, preferably the time to rinse the sample line of the desired slurry, here shown as RinsePumpLineYTime. In addition, PV1.0y, where y is the desired slurry line, is also opened. Following this, it is determined 362 whether there is chemical in the manifold. If so 364 the manifold is rinsed. If not, or after rinsing, 366 the manifold inlet valve PV1.0y where y is the supply slurry sample number is opened for a desired time representing the chemical charge for line Y to fill the sample lines, the manifold and to get to and past valve SV15. Additionally, the signal asking for chemical to be sent is sent to the data concentrator. Following this, at 368 the recipe file name representative of the particular supply slurry recipe is sent to the particle analyzer along with a start signal. The analyzer then activates valve SV15 for a sample flow time. Following this, at 370 the analyzer sends a signal indicating that the valve SV15 has deactivated. It is then determined 372 whether the Line Rinse Enabled flag is active. If so, a signal to rinse the pump line is sent to the data concentrator for a desired time to rinse the sample line of the slurry sample. When complete, the signal asking for chemical to be sent is also terminated, and the appropriate valves are closed thereafter. After this procedure, and if the Line Rinse Enabled flag is not active, the system is flushed 376 and the procedure is completed 378.

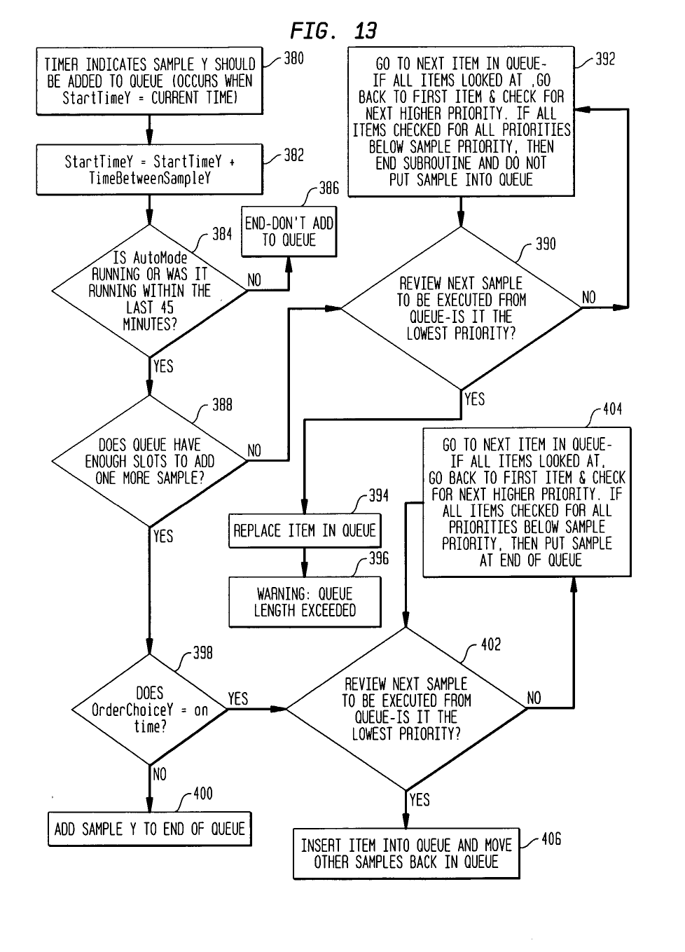

Referring now to FIG. 13, the iSPEQ process flow queuing procedure is illustrated, by which it is determined which sample is to be used in what order. At the start 380 a timer indicates that a sample Y should be added to the queue, which occurs when the time to take one sample equals the current time. The time to take one sample is then recalculated 382 to add a delay time indicative of the time between the start of measurement and the start of the next measurement for the same sample. It is then determined 384 whether auto mode is running or if it has been running for a given period. If not, this procedure is ended without adding to the queue 386. If so, it is determined 388 whether the queue has enough slots to add one more sample. If not 390 the next sample is reviewed to be executed from the queue and it is determined whether it is the lowest priority. If it is not the lowest priority 392 the procedure goes to the next item in the queue and if all items have been looked at the system circles back to the first item and checks for the next higher priority. If all the items checked were all priorities below the sample priority then the process is complete and the sample is not put into the queue. If the sample is the lowest priority, the current sample is replaced in the queue with a higher priority sample. However, a warning is issued indicating that the queue length has been exceeded 396. When the queue does have enough slots to add one more sample, another determination 398 whether the request is made on time, and if not the sample is added to the end of the queue 400. If the request is made on time then in 402 the next sample is executed from the queue and it is determined whether it is the lowest priority. Again, if it is not the lowest priority the next item in the queue is searched and so on. If all the items are checked for all priorities below the sample priority, then the sample is put at the end of the queue 404. If the next sample is the lowest priority then in 406 the current sample is inserted into the queue and the other samples in the queue are moved back.

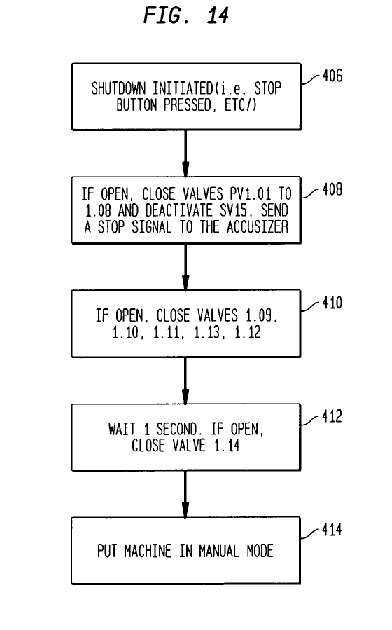

Referring now to FIG. 14, the iSPEQ process flow shutdown mode is illustrated. When the shutdown is initiated 406 (as by pressing a stop button, etc.) if the manifold valves are open, they are closed 408 and the valve SV15 connected to the particle sensor is deactivated, and a stop signal is sent to the particle analyzer. If open 410 the valves connecting nitrogen or purging supply to the system are closed along with the probe cleaning solution valves. Following these closures 412 the system waits for a desired period of time, in this case one second, and then if open valve connecting the purging supply to the manifold is closed. Finally, at 415 the machine is then put into manual mode. The shutdown mode ensures that the system is depressurized.

The present invention has been described in terms of the preferred embodiment, and it is recognized that equivalents, alternatives, and modifications, aside from those expressly stated, are possible and within the scope of the appending claims.

For example, although chemical-mechanical polishing slurries are described as being used with the present invention, those of ordinary skill in the art will appreciate that other types of slurries and liquids are anticipated as being used with the present invention, as part of a liquid sampling system. In addition, other orientations of the manifold, other than vertical, for example horizontal, are contemplated. Other types of flushing liquids, other than water, may be used, including acids, bases or other cleaning chemicals. Also, the system is not required to have a vent, and in some embodiments may not have one. Moreover, the system may aspirate slurries or chemicals into other types of equipment and sensors.

What is claimed is:

1. A slurry sampling system for use with a plurality of slurry samples supplied by a plurality of slurry supply lines comprising:
an analyzer for optically analyzing particles within the slurry samples; and
a manifold in operational association with the analyzer having a plurality of inlet ports to selectively receive the slurry samples from the slurry supply lines, each inlet port associated with one of the slurry samples, and having an outlet port capable of allowing each of the slurry samples to exit the manifold and proceed to the analyzer;
wherein the manifold and the analyzer operate such that each of the slurry samples may be selectively passed through the manifold and subsequently collected and analyzed by the analyzer without contamination from any other of the slurry samples.

2. The slurry sampling system of claim 1 wherein the system can operate in at least one of an automatic mode, a manual mode, and a bottle sample mode.

3. The slurry sampling system of claim 2 wherein in the automatic mode the system automatically initiates a system flush to flush the manifold with a flushing fluid after the analyzer collects one of the slurry samples for analysis.

4. The slurry sampling system of claim 2 wherein in the manual mode the system initiates a system flush to flush the manifold with a flushing fluid after the analyzer collects one of the slurry samples for analysis and then remains idle following the system flush until one of the operating modes is selected again.

5. The slurry sampling system of claim 2 wherein in the bottle sample mode, a sample is drawn from a bottle through a bottle sample port of the manifold and through the manifold into the analyzer for collection and measurement of the sample from the bottle.

6. The slurry sampling system of claim 5 wherein in the bottle sample mode the slurry sample is one of aspirated and pumped through the bottle sample port of the manifold.

7. The slurry sampling system of claim 1 wherein the manifold includes six inlet ports for receiving the slurry samples from the slurry supply lines.

8. The slurry sampling system of claim 1 wherein the manifold further includes a venting port to vent the manifold.

9. The slurry sampling system of claim 1 further including a plurality of valves disposed between the manifold and the supply lines for selectively controlling the entrance of the plurality of slurry samples into the inlet ports of the manifold.

10. The slurry sampling system of claim 9 wherein the valves are three-way valves and wherein at least a portion of each of the three-way valves may be connected to a slurry sample outlet line to permit removal of any excess of the slurry samples from the slurry sampling system.

11. The slurry sampling system of claim 1 wherein the slurry samples analyzed by the analyzer are chemical-mechanical polishing (CMP) slurries.

12. The slurry sampling system of claim 1 wherein the manifold includes six slurry sample inlet ports, a bottle sample inlet port and a venting port.

13. The slurry sampling system of claim 1 wherein the manifold includes a venting port and wherein the venting port is connected via a drain line to a system drain.

14. The slurry sampling system of claim 1 wherein the slurry samples are supplied to the manifold with a plurality of slurry supply lines.

15. The slurry sampling system of claim 1 wherein the manifold further includes a manifold intake connected to a manifold flushing fluid supply.

16. The slurry sampling system of claim 1 wherein the manifold further includes a manifold intake connected to a manifold purging gas supply.

17. The slurry sampling system of claim 1 wherein the manifold further includes a manifold intake in communication with both a manifold flushing fluid supply line and a manifold purging gas supply line to selectively receive a manifold flushing fluid and a manifold purging gas, respectively, into the manifold.

18. A sampling system comprising:
a single optical particle counter for measuring a plurality of chemical-mechanical polishing slurries; and
a manifold in operational association with the optical particle counter;
wherein the manifold includes a plurality of ports capable of selectively receiving the chemical-mechanical polishing slurries to be analyzed by the optical particle counter.

19. The system of claim 18 further including a plurality of supply valves, each supply valve connected to the manifold to selectively receive the chemical-mechanical polishing slurries therethrough and into the manifold.

20. The system of claim 18 wherein the manifold includes an outlet port such that the chemical-mechanical polishing slurries are capable of exiting from the manifold through the outlet port.

21. The system of claim 18 wherein each port is associated with a slurry line to receive one of the slurries and further including a supply valve connected to each port to selectively pass the slurries through the ports into the manifold.

22. A sampling system for use with an optical particle counter comprising:
a multiple port manifold capable of receiving a plurality of chemical slurries and passing each of the slurries to the optical particle counter to allow the optical particle counter to sample multiple sample points;
wherein at least one of the ports is connected to a bottle sample line that is connected to a sample bottle having a sample therein to be introduced into the manifold.

23. A manifold for use with chemical-mechanical polishing slurries including a plurality of sampling ports, each sampling port selectively allowing one of the chemical-mechanical polishing slurries into the manifold.

24. A method of multiple slurry sampling measurement, the method comprising:
flushing a manifold with a flushing fluid;
flushing an analyzer sample loop with the flushing fluid;
collecting and analyzing the flushing fluid with an analyzer;
purging the manifold and the analyzer sample loop with a purging gas to remove the flushing fluid;
selectively passing a slurry sample through the manifold;
sampling the slurry sample with the analyzer; and
analyzing the slurry sample.

25. A method of multiple slurry sampling measurement, the method comprising:
selectively passing a plurality of slurry samples one at a time through a manifold having multiple slurry sample ports, each slurry sample port capable of receiving one of the plurality of slurry samples;
measuring the plurality of slurries passed through the manifold with a single slurry particle analyzer.

26. The method of claim 25 wherein the method includes purging the manifold.

27. The method of claim 26 wherein the purging step includes purging the manifold with nitrogen.

28. The method of claim 26 wherein the purging step includes purging the manifold with an ultra-pure gas.

29. The method of claim 26 wherein the purging step includes purging the manifold with argon.

30. The method of claim 26 wherein the purging step includes purging the manifold with an inert gas.

31. The method of claim 25 wherein the method further includes flushing the manifold with ultra-pure water.

32. The method of claim 25 wherein the method further includes flushing the manifold with de-ionized water.

33. The method of claim 25 wherein the method further includes flushing the analyzer with ultra-pure water.

34. The method of claim 25 wherein the method further includes flushing the analyzer with a compatible flushing fluid having a pH between 4 and 12 selected from the group consisting of potassium chloride, hydrochloric acid or ammonium hydroxide.

35. A method of sampling comprising:
flushing a manifold having multiple sample ports with de-ionized water;
with an analyzer, measuring the water from the flushing of the manifold;
purging the water from the manifold with nitrogen;
drawing a slurry sample through the sample valve, into one of the manifold sample ports, and through the manifold;
selectively receiving the slurry sample into the analyzer;
analyzing the slurry sample; and
flushing the manifold to remove the slurry sample from the manifold.

36. The method of claim 35 wherein the flushing, purging and drawing steps are accomplished by aspirating an aspirating liquid to draw the water, nitrogen and slurry sample through the manifold.
